(19) United States
(12) Patent Application Publication
(10) Pub. No.: US 2023/0018642 A1
(43) Pub. Date: Jan. 19, 2023

(54) BATTERY HOUSING FOR RECEIVING AT LEAST ONE BATTERY CELL MODULE

(71) Applicant: Mahle International GmbH, Stuttgart (DE)

(72) Inventors: Peter Geskes, Ostfildern (DE); Ingo Haeusler, Esslingen (DE); Dierk Hoffmann, Leonberg (DE); Martin Janssen, Rechberghausen (DE); Ruediger Knauss, Kernen i.R. (DE); Peter Ruppricht, Esslingen (DE); Nico Storz, Reichenbach (DE)

(21) Appl. No.: 17/866,459

(22) Filed: Jul. 15, 2022

(30) Foreign Application Priority Data
Jul. 16, 2021 (DE) 10 2021 207 623.8

(51) Int. Cl. H01M 50/233; H01M 10/658; H01M 50/224

(52) U.S. Cl. CPC H01M 50/233; H01M 10/658; H01M 50/224

(57) ABSTRACT

A battery housing for receiving at least one battery cell module is disclosed. The battery housing includes at least one housing part surrounding a housing interior. A film composed of a metal is arranged, at least in portions, on an outside of the at least one housing part facing away from the housing interior. A studded structure is provided on a surface of the film facing away from the at least one housing part. The studded structure includes a plurality of studs arranged spaced apart from one another and projecting from the surface of the film. The plurality of studs support themselves on the outside of the at least one housing part.

### CROSS-REFERENCE TO RELATED APPLICATION

This application claims priority to German Application No. DE 10 2021 207 623.8 filed on Jul. 16, 2021, the contents of which are hereby incorporated by reference in its entirety.

### TECHNICAL FIELD

The invention relates to a battery housing for receiving at least one battery cell module and to an arrangement having such a battery housing, in which at least one battery cell module is arranged.

### BACKGROUND

According to legal provisions, battery housings for receiving battery cell modules for motor vehicles have to be often designed so that the battery cell modules received in the battery housing are protected, for at least a certain period of time, against a fire load acting from the outside.

In this connection it is known to provide conventional battery housings with a fire protection layer which is arranged inside on the battery housing and thus protects against a fire load in the interior of the battery housing.

A battery housing designed in such a manner is described in DE 10 2019 207 464 A1.

An object of the present invention is to show new ways in developing battery housings with integrated fire protection function.

This object is solved through the subject of the independent patent claim(s). Preferred embodiments are subject of the dependent patent claims.

### SUMMARY

Accordingly, the basic idea of the invention is to arrange on an outside of a battery housing facing away from the housing interior a fire protection film made of metal, which is provided with a studded structure facing the battery housing. This studded structure comprises a plurality of studs projecting from the surface of the film, as a result of which it is achieved that the actual film substantially forms only point-contacts with the battery housing. Because of this, the actual fire protection film is positioned spaced apart from the battery housing. This in turn has the consequence that between the film and the battery housing an intermediate space is created, which upon an external flame load, i.e. upon flame impingement of the film material, brings about a greatly reduced heat transfer into the housing interior of the battery housing. The heat conduction into the material of the battery housing is also significantly reduced in this way. As a result, battery cell modules arranged in the housing interior are protected against overheating as desired.

A further advantage of the use of a film made of metal proposed here consists in that the same—additionally to the fire protection function according to the invention—brings about a shielding of the housing interior with the battery cell modules arranged therein relative to electromagnetic radiation present in the external environment of the battery housing. Separately providing such an electromagnetic shield—also known by the designation “EMC shielding” to the person skilled in the art—can therefore be omitted.

A battery housing according to the invention serves for receiving at least one battery cell module. The battery housing includes at least one housing part surrounding a housing interior, which comprises an inside facing the housing interior and an outside facing away from the housing interior. Further, the battery housing includes a film, in particular a fire protection film, made of a metal which is arranged, at least in portions, on the outside of the housing part facing away from the housing interior. Preferably, the film or fire protection film covers the entire outside of the housing part so that the protective effect achieved relative to an only partial covering is maximised.

According to the invention, a studded structure is formed on a surface of the film facing the housing part. This studded structure that is substantial for the invention includes a plurality of studs which project away from the surface of the film towards the housing part and support themselves on the outside of the housing part. The individual studs are arranged spaced apart from one another. In this way, the thermal coupling between the film and the housing part is kept low.

According to a preferred embodiment, the film is, preferentially exclusively, connected to the housing part by means of the studs, so that between the film and the housing part an intermediate space is formed. This intermediate space acts as thermal insulation between the housing part and the film, so that the heat conduction from the external environment of the battery housing into the housing interior can be kept low.

According to an advantageous further development, the intermediate space formed by means of the studs between the film and the housing part can be at least partially, preferably completely, filled with a thermal insulation. In this way, the thermal shielding of the housing interior relative to the external environment can be further improved.

Practically, the thermal insulation can include a foam material or a fibre fleece or consist of a foam material or fibre fleece. Such materials can be easily introduced into the intermediate space in order to fill the same, preferentially completely.

According to a preferred embodiment of the invention, the studs, for forming the studded structure, are arranged grid-like on the surface of the film. This makes possible producing the studded structure by means of a stamping operation, known to the relevant person skilled in the art in particular by the designation “spherical cap stamping”. This in turn advantageously allows the person skilled in the art to vary size and geometrical shaping of the produced studded structure in a user- and requirement-specific manner across various regions of the housing part. In addition, commercially available metal films can be used which are delivered—in particular as rolled goods—already provided with such a studded structure.

Alternatively to this however it is also conceivable to arrange a smooth metal film flat on the housing part and introduce the studded structure into the film only subsequently—for example by means of a vacuum applied over the area—during the course of producing the battery housing. This variant also allows individually configuring the studded structure dependent on region.

A preferred embodiment, in which the studs have a stud height, measured perpendicularly to the surface of the film, which amounts to between 2560 μm and 2680 μm, preferentially between 1020 μm and 1150 μm has proved to be practical. Studs with such a dimensioning can be particularly easily produced in particular by means of a stamping operation.

Just as practically, a total film height measured perpendicularly to the surface of the film can amount to between 1.5 mm and 5.3 mm.

Alternatively or additionally to this, a ratio of the stud height to a stud spacing of two adjacent studs can amount to between 0.15 and 0.25. Thus, a sufficiently large volume of the intermediate space is ensured.

According to an advantageous further development, at least one stud, particularly multiple studs, particularly preferably all studs of the studded structure has/have a spherical segment-shaped, in particular semi-spherical-shaped or truncated cone-shaped or truncated pyramid-shaped or serpentine geometrical form. In this way, the effective size of the total mechanical contact area of the film with the housing part of the battery housing and thus also the thermal contact of the film with the housing part can be user-specifically adjusted.

Practically, the metal of the film can be aluminium or stainless steel. The studded structure can be particularly easily introduced into these materials during the course of producing the film.

According to an advantageous further development, the battery housing is formed at least in two parts and includes a first and a second housing part. In this further development, the first housing part is formed by a housing pot comprising a housing opening and the second housing part is formed by a housing lid, by means of which the housing opening of the housing pot can be closed or is closed. This variant has proved to be particularly suitable for receiving battery cell modules.

Practically, the studded structure with the studs can be formed by means of a stamping operation. Thus, the effective size of the entire mechanical contact area of the film with the housing part of the battery housing and thus also the thermal contact of the film with the housing part can be user-specifically adjusted.

Practically, the material of the housing can be a plastic, preferentially a thermoplastic. Alternatively to this, the material of the housing part can be a metal.

The invention also relates to a battery arrangement having a battery housing according to the invention introduced above and having at least one battery cell module arranged in the housing interior of the battery housing. The advantages of the battery housing according to the invention explained above therefore apply also to the battery arrangement according to the invention.

Further important features and advantages of the invention are obtained from the subclaims, from the drawing and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically:

FIG. 1 a first housing part of the battery housing according to the invention formed as housing pot with fire protection film, in a perspective representation,

FIG. 2 a second housing part of the battery housing according to the invention formed as housing lid with fire protection film, likewise in a perspective representation,

FIG. 3 the fire protection film arranged outside on the housing lid of FIG. 2 in a separate perspective representation,

FIG. 4 a sectional representation of the housing lid shown in FIG. 2, in which the arrangement of the studded structure on the housing lid is noticeable,

FIG. 5 a further development of the housing lid of FIG. 3, in which in the intermediate space formed between the film and the housing lid by means of the studded structure a thermal insulation is arranged.

### DETAILED DESCRIPTION

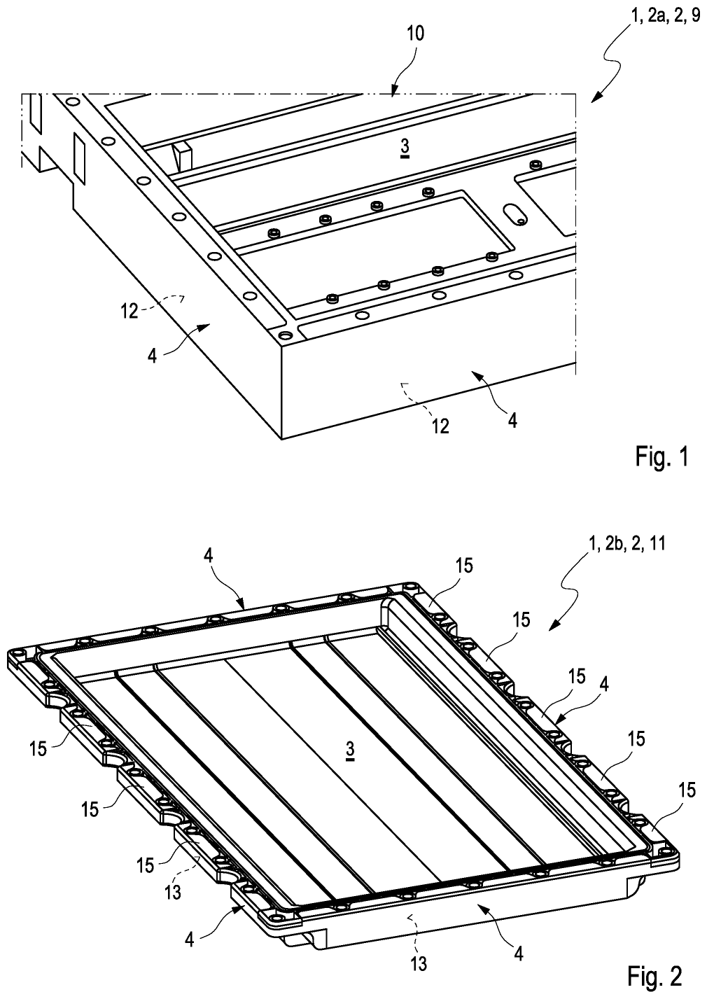

The FIGS. 1 and 2 each show exemplarily a housing part 2 of a battery housing 1 according to the invention in a perspective representation. In the example of the figures, the battery housing 1 is formed in two parts having a first and having a second housing part 2a, 2b, wherein the FIG. 1 shows the first housing part 2a and FIG. 2 the second housing part 2b. The first housing part 2a is formed by a housing pot 9 comprising a housing opening 10. The second housing part 2b is formed by a housing lid 11, by means of which the housing opening 10 of the housing pot 9 can be closed. The two housing parts 2a, 2b that is the housing pot 9 and the housing lid 11, surround, in a state of the housing lid mounted on the housing pot 9, in which the same closes the housing opening 10, surround a housing interior 3.

Preferably, a plastic, preferably a thermoplastic, can be used as material for the housing parts 2a, 2b. Alternatively to this however a metal can also be considered as material for the housing parts 2a, 2b.

Further, the battery housing 1 according to the FIGS. 1 and 2 includes a film 4 made of a metal, for example of aluminium or of stainless steel, which is arranged on an outside 12 of the first housing part 2a (see FIG. 1) facing away from the housing interior 3, and also on an outside 13 of the second housing part 2b (see FIG. 2) facing away from the housing interior 3. In the example of FIG. 1, the film 4 covers the outside 12 of the first housing part 2a, i.e. of the housing pot 9, completely. Thus, the film 4, seen by itself, has the same geometrical form as the housing pot 9, i.e. a pot-like geometry.

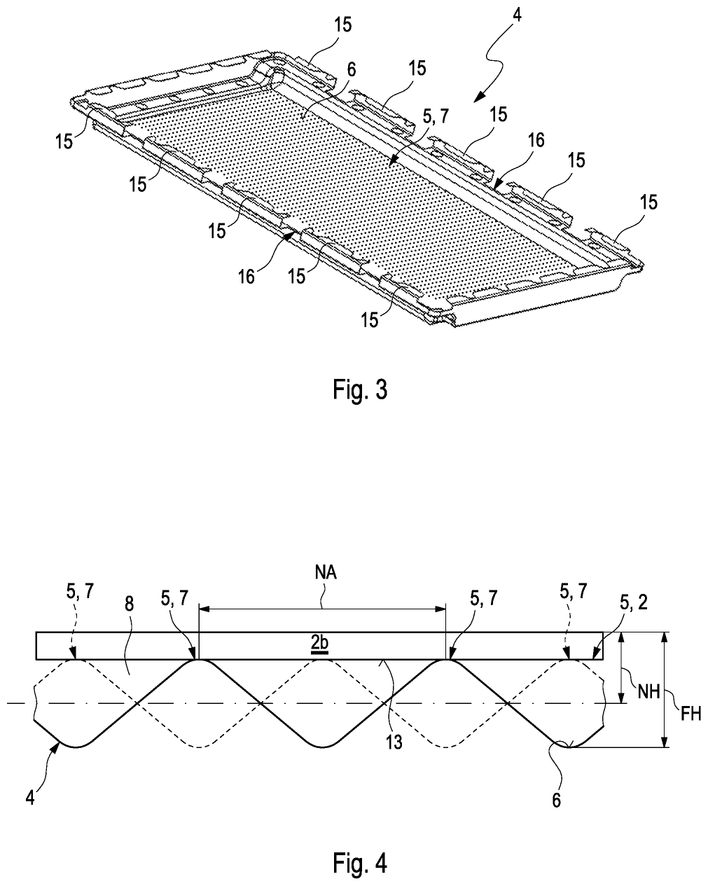

FIG. 3 shows the film 4 shown in FIG. 2 and arranged outside on the second housing part 2b, that is the housing lid 11 in a separate perspective representation. The film 4 functions as fire protection film for the battery housing 1. As is noticeable from FIG. 3, a studded structure 5 is formed on a surface 6 of the film 4 facing the second housing part 2b or the housing lid 11. This studded structure 5 that is indicated only roughly schematically in the representation of FIG. 3 and not noticeable in the FIGS. 1 and 2 includes a plurality of studs 7 arranged spaced apart from one another and projecting from the surface 6 of the film 4. These studs 7 support themselves on the outside 12 of the first housing part 2a, or on the outside 13 of the second housing part 2b. As illustrated in FIG. 3, the studs are arranged grid-like for forming the studded structure 5 on the surface 6 of the film 4. The studded structure 5 with the studs 7 can be in the form of a stamping, i.e. produced by means of a stamping operation.

The studs 7 of the studded structure 5 indicated only roughly schematically in FIG. 3 can have different geometrical forms. Conceivable is a truncated cone-shaped or truncated pyramid-shaped or serpentine geometrical form. Whereas with the truncated cone-shaped and truncated pyramid-shaped geometrical form, each individual stud 7 in each case substantially forms a point-contact with the respective housing parts 2a, 2b, a line contact is realised with the serpentine geometrical form. Here it is conceivable that the individual studs 7 have a different geometrical form. It is conceivable, in particular to combine the geometrical forms of the studs 7 in the studded structure 5 explained above with one another.

As is additionally illustrated in FIG. 3, multiple fastening elements 15 each with a clip-like geometry are provided on an encircling edge 16 of the film 4 spaced apart from one another, which in each case project from the film at an angle and can support fixing the film 4 to the housing lid 11 (see FIG. 3). When the material of the housing lid 11 is a metal, an electrical connection between the film 4 and the housing lid can be improved in this way.

FIG. 4 is a part representation of the second housing part 2b and the film 4 arranged thereon in a section. Accordingly, the studs 7 can also have a spherical segment-shaped geometrical form. A semi-spherical-shaped geometrical form which is not shown is also conceivable as an alternative thereto.

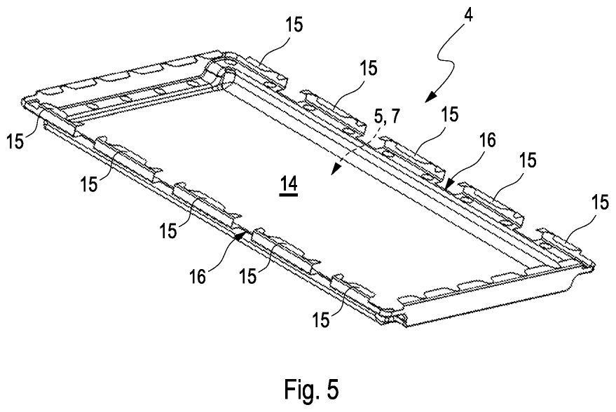

As illustrated by FIG. 4, the studs 7 have a stud height NH measured perpendicularly to the surface 6 of the film 4 which in the example scenario amounts to between 2560 μm and 2680 μm, preferentially between 1020 μm and 1150 μm. A total film height FH measured perpendicularly to the surface 6 of the film 4, which also includes the stud height NH shown in FIG. 5, amounts to between 1.5 mm and 5.3 mm. A ratio of the stud height NH to a respective stud spacing NA of two adjacent studs 7 can amount to between 0.15 and 0.25.

As is additionally evident from FIG. 4, the film 4 is mechanically connected to the second housing part 2b exclusively by means of the studs 7, so that between the film 4 and the housing part 2 intermediate spaces 8 are formed.

FIG. 5 shows in an analogous manner to FIG. 3 the film 4 in a separate perspective representation. The FIG. 5 illustrates that the intermediate space 8 formed between the film 4 and the second housing part 2b by means of the studs 7 can be filled with a thermal insulation 14. The thermal insulation 14 can be formed by a foam material or by a fibre fleece.

1. A battery housing for receiving at least one battery cell module, comprising:
at least one housing part surrounding a housing interior,
a film composed of a metal arranged, at least in portions on an outside of the at least one housing part facing away from the housing interior,
wherein on a surface of the film facing the at least one housing part a studded structure is provided that includes a plurality of studs arranged spaced apart from one another and projecting from the surface of the film, wherein the plurality of studs support themselves on the outside of the at least one housing part.

2. The battery housing according to claim 1, wherein the film is connected to the at least one housing part via the plurality of studs such that between the film and the at least one housing part at least one intermediate space is provided.

3. The battery housing according to claim 2, wherein the at least one intermediate space is at least partially filled with a thermal insulation.

4. The battery housing according to claim 3, wherein the thermal insulation includes a foam material or a fibre fleece.

5. The battery housing according to claim 1, wherein the plurality of studs, for providing the studded structure, are arranged grid-like on the surface of the film.

6. The battery housing according to claim 1, wherein the plurality of studs each have a stud height measured perpendicularly to the surface of the film, that amounts to between 2560 μm and 2680 μm.

7. The battery housing according to claim 1, wherein a total film height measured perpendicularly to the surface of the film amounts to between 1.5 mm and 5.3 mm.

8. The battery housing according to claim 6, wherein a ratio of the stud height to a stud spacing of two adjacent studs amounts to between 0.15 and 0.25.

9. The battery housing according to claim 1, wherein at least one stud of the studded structure has a spherical segment-shaped form, a truncated cone-shaped form, a truncated pyramid-shaped form, or serpentine geometrical form.

10. The battery housing according to claim 1, wherein the metal of the film is aluminium or stainless steel.

11. The battery housing according to claim 1, wherein the studded structure with the plurality of studs is stamped.

12. The battery housing according to claim 1, wherein the at least one housing part includes a first housing part and a second housing part, wherein the first housing part is structured as a housing pot comprising a housing opening and the second housing part is structured as a housing lid that closes the housing opening of the housing pot.

13. The battery housing according to the claim 1, wherein a material of the at least one housing part includes a plastic or a metal.

14. A battery arrangement, comprising:
a battery housing, the battery housing including:
at least one housing part surrounding a housing interior,
a film composed of a metal arranged, at least in portions on an outside of the at least one housing part facing away from the housing interior,
wherein on a surface of the film facing the at least one housing part a studded structure is provided that includes a plurality of studs arranged spaced apart from one another and projecting from the surface of the film, wherein the plurality of studs support themselves on the outside of the at least one housing part, and
at least one battery cell module arranged in the housing interior of the battery housing.

15. The battery arrangement according to claim 14, wherein the film is a fire protection film and is connected to the at least one housing part via the plurality of studs such that at least one intermediate space is provided between the film and the at least one housing part.

16. The battery arrangement according to claim 15, wherein the at least one intermediate space is at least partially filed with a thermal insulation.

17. The battery arrangement according to claim 16, wherein the thermal insulation includes a foam material or a fibre fleece material.

18. The battery arrangement according to claim 14, wherein the plurality of studs are arranged in a grid-like pattern on the surface of the film.

19. The battery arrangement according to claim 14, wherein the plurality of studs each have a stud height, measured perpendicularly to the surface of the film, that amounts to between 1020 μm and 1150 μm.

20. The battery arrangement according to claim 14, wherein the metal of the film is aluminium or stainless steel.
